(19) United States
(12) Patent Application Publication
(10) Pub. No.: US 2023/0306438 A1
(43) Pub. Date: Sep. 28, 2023

(54) SUPPLY CHAIN COMPARISON VIA AI ETHICS SCORES

(71) Applicant: Dell Products L.P., Round Rock, TX (US)

(72) Inventors: Nicole Reineke, Northborough, MA (US); Stephen J. Todd, North Andover, MA (US)

(21) Appl. No.: 17/655,920

(22) Filed: Mar. 22, 2022

(51) Int. Cl. G06Q 30/00; G06Q 10/06; G06Q 30/06

(52) U.S. Cl. CPC G06Q 30/018; G06Q 10/06315; G06Q 10/06375; G06Q 30/0633

(57) ABSTRACT

One example method includes building a computing asset that includes a component that has been verified as being ethically sourced, generating a bill of material for the computing asset that identifies the component, adding the bill of material to a data confidence fabric that includes the computing asset as a node, registering the component and the bill of material in the data confidence fabric, and associating a digital fair trade/ethics signature with the component, wherein the digital fair trade/ethics signature is stored in the data confidence fabric in association with the component.

### FIELD OF THE INVENTION

Embodiments of the present invention generally relate to ethical sourcing of computing infrastructure. More particularly, at least some embodiments of the invention relate to systems, hardware, software, computer-readable media, and methods for enabling parties, such as vendors and consumers, to establish the ethical sourcing of computing infrastructure assets.

### BACKGROUND

Companies lack insight into the ethical sourcing of computing infrastructure such as, for example, computing assets that are included in data centers, cloud computing environments, edge computing environments, and on-premises computing environments. At present, there is no way for an entity to be sure that it is only sourcing, and using, its computing infrastructure based on the certification of computing infrastructure assets with fair trade, and other, practices.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a configuration and process for association of an ‘ethically sourced asset’ signature for an asset, and data.

FIG. 2 discloses registration of a bill of material component ethics source signature.

FIG. 3 discloses use of a DCF signature to populate an asset catalog.

FIG. 4 discloses addition of asset ethics metadata notation on data registration.

FIG. 5 discloses actionable use of ethics asset scores associated with data.

FIG. 6 discloses a lifecycle flow of a piece of data in association with assets that may or may not have been ethically sourced.

FIG. 7 discloses aspects of an example computing entity operable to perform any of the claimed methods, processes, and operations.

### DETAILED DESCRIPTION OF SOME EXAMPLE EMBODIMENTS

Embodiments of the present invention generally relate to ethical sourcing of computing infrastructure. More particularly, at least some embodiments of the invention relate to systems, hardware, software, computer-readable media, and methods for enabling parties, such as vendors and consumers, to establish the ethical sourcing of computing infrastructure elements.

In general, example embodiments of the invention may operate in connection with a DCF (data confidence fabric), although that is not necessarily required. A DCF may be overlaid on, or comprise, a grouping of computing elements, where the computing elements may comprise hardware and/or software.

A DCF may collect and insert data and/or metadata - collectively, ‘confidence information’ - about the DCF nodes that handle the data in some way as the data passes through the DCF. Such DCF nodes may comprise various types of computing entities or computing assets. This confidence information may be associated with the data so that a user can assess, for example, the trustworthiness of the data, based on the DCF nodes with which the data has interacted in some way.

In example embodiments, the DCF may insert additional data and/or metadata concerning the DCF nodes. This additional data and/or metadata may comprise information about a supply chain associated with the component(s), such as computing entities for example, that make up one or more DCF nodes. In more detail, embodiments of the invention may extend the data collected about an asset of a DCF node to also include asset-level BOM (bill of material) registration. This registration may prove that an asset, and its respective components, have been ethically sourced. The registration metadata may be associated with the data so that a prospective customer or vendor accessing the data may be able to see the registration metadata. Thus, this asset registration metadata may be used to extend the information, such as confidence information, that is created on and/or about a node of a DCF as data interacts with that node.

Finally, embodiments may enable evaluation of an asset before and/or after the asset is obtained and included as part of a DCF. Thus, existing DCFs may be evaluated after-the-fact for ethical sourcing of their assets. As well, a potential purchaser may evaluate an asset, for ethical sourcing, prior to purchasing the asset.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, some embodiments of the invention may enable an organization to evaluate the sourcing of its computing assets. An embodiment of the invention may enable an organization to use its DCF to automatically associate sourcing information with one or more of the nodes of the DCF. An embodiment of the invention may enable a user, vendor, or other entity, to reliably determine whether or not an asset has been ethically sourced. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

### A. Circumstances Addressed by Example Embodiments

In general, example embodiments may prevent, or resolve, various circumstances that may exist in some operating environments. Some examples of these are addressed below.

For example, vendors do not currently have a way to capture the ethical sourcing of their components and assets in a way that can be utilized for customer decision making post purchase. Further, companies lack insight into the ethical sourcing of computing infrastructure assets. There is not currently a way for companies to only use or source their infrastructure based on the certification of resources with fair trade practices.

As another example, purchasers, vendors, and other parties, have no mechanism to trace the ethics of the assets that were used to create, transit, mutate, or analyze, their data. Further, when sourcing data and generating data sets, there is no way for a company to access, or consider, the ethics associated with the creation and procurement of the assets on which the data was generated, accessed, or manipulated.

To illustrate, consider an encrypted sensor reading that moves across a gateway and onto an edge server. The edge server then decrypts and analyzes the data in the context of a trusted execution environment, for example, a TEE, such as Intel SGX. The analysis results in a business insight that may be actionable. Before the insight is processed, an application may query: is the edge server or the TEE on which this insight was generated trustworthy? Was the TEE manufactured in an ethical manner? Was the edge server manufactured ethically? If the answer is ‘no’ for either of these questions, the business may be putting itself at risk by analyzing data on hardware that was unethically created and/or sourced. Problems such as these may extend themselves to any hardware that creates, transfers, mutates, or analyzes data. Unfortunately, there are no mechanisms in this field to tie the data operations to the ethical sourcing of the relevant hardware components.

Another example concerns the present inability to use data asset path ethics scores in determining the value of data for use in data marketplaces. In particular, the inability to associate data assets with ethical hardware production and sourcing results in a secondary problem, namely, data valuation based on buyer wariness of unethically processed data. The rise of data marketplaces and exchanges presents an opportunity for data sellers and data buyers. However, current data marketplaces/exchanges offer no capability for a data seller to advertise the ethical handling of the data as it was brought to sale. This lack of ethical transparency can result in (a) lower sales prices, or (b) no sale at all. Similarly, a data buyer has no access to provenance or history related to the generation and handling, at least insofar as ethics are concerned, of the data they desire to purchase. As a result, the purchase and use of unethically-sourced data may expose the buyer to risk, which the buyer may or may not even be aware of.

As a final example, without a record of asset ethics, it may not be possible to route data away from or around components that are not ethically produced or sourced. Particularly, if data is initially created in an ethical manner, for example, a sensor has an established, provable lineage of ethical componentry, a time may come when the data from that trustworthy sensor must go through the transit process and move to a separate hardware component, such as a gateway for example. At present however, components such as this example sensor have no visibility into the ethical viability of that hardware component, that is, the gateway in this example. Thus, if the sensor transfers the data to that ethically questionable, or at least unverified, component, the veracity and trustworthiness of the data could be lost. These same considerations may apply to any future “hop” the data takes, for example, from the gateway to the edge server, and the edger server to a cloud environment. These concerns may be exacerbated by the fact that ethically sourced hardware components may have the choice to send data across one or more of several different paths. But such components may have no visibility into the upstream ethical viability of any given data path.

### B. Overview

Distributed decision making is putting an increased focus on the importance of understanding the assets on which decisions are made. In some cases, an organization may be using edge devices to run AI (artificial intelligence) and make real-time decisions, while in other cases, organizations may be using data that is created on one asset and accessed on another.

One aspect that may be important, but is not currently captured or usable, is the ethical production, and sourcing, of the components of any infrastructure asset, where such infrastructure assets may include environments, entities, and components such as, but not limited to, data centers and their components, cloud computing environments and their components, edge computing environments and their components including edge devices, near-edge computing environments, DCFs, DCF nodes, and clients, that may be involved in decision making, regarding data, and/or data creation.

While this information may be of great interest to prospective purchasers, and others, vendors do not currently have a registration mechanism, regarding their components, that establishes ethical sourcing of those components and the material(s) from which the components are made. Moreover, actual and prospective customers do not, in any event, have a way to access or utilize such information when they are in their component sourcing decision-making processes.

In view of considerations such as these, example embodiments are directed to methods and mechanisms that may enable parties, such as vendors, to register the component and asset level certification of ethical sourcing using a DCF. Briefly, a DCF may provide a mechanism that enables any asset register itself and metadata about itself and/or about DCF nodes with which the data has interacted, with a decentralized ledger. In some instantiations, the asset may do this in the context of data registration. Further, in some example embodiments, this notion may be extended to include component-level details of any assets, such as assets that make up one or more nodes of a DCF, as well as external certification details for third-party validation of ethical sourcing of those assets.

More particularly, example embodiments may provide for the registration of a BOM and component digital fair trade/ethics signature, while also adding metadata regarding the ethical sourcing of the assets, components, and all data that passes across those assets and components. Embodiments may then use this signature to calculate asset or data scores, and subsequently use those scores for activities such as data set generation, data marketplaces, asset purchasing decisions, workload orchestration placement decisions, and more.

### C. Aspects of Example Embodiments of the Invention

In general, example embodiments embrace techniques that may enable a vendor, purchaser, user, or other entity, to establish the ethical sourcing of an asset and its components. When ethical sourcing information, which may include both data and metadata, is associated with assets and their components and materials, a suite of business logic may subsequently protect a business from using assets, which may comprise hardware, software, and/or, data, that do not meet their fair trade / ethical sourcing standards. Note that as used herein, ‘sourcing’ is intended to be broadly construed. Thus, ‘sourcing’ includes, but is not limited to, the sourcing and procurement of the components and materials included in an asset, as well as the chain of custody of the asset and its components during, and after, production of the asset, until final delivery to an end user.

### C.1 Definitions

Various terms are used herein with respect to aspects of example embodiments. Following are definitions of selected terms.
1. BOM (Bill of Materials) score - the cumulative result of a comparison of the components that comprise any asset to the respective ethical context requirements of such component, and creation of a numerical assessment of the alignment of the asset(s) components with the ethical context required by the consumer of the assets and measurement standards;
2. DCF ethics score - the cumulative result of a comparison of any asset (such as, for example, hardware, software, data, lifecycle, user, or security), or cumulative data leading to a particular point in time in the life of an asset, with the required ethical context of the asset, and creation of a numerical assessment of the alignment of the asset to the context requirements;
3. DCF ethics signature - as used herein, a ‘signature’ generally comprises a verification of some type, such as from a third party, that information or data, for example, has been checked and verified by that third party as being accurate and complete - thus, a DCF ethics signature may be appended to a DCF ethics score;
4. BOM ethics audit signature - an assertion is that there is an external auditor, or other entity, that has verified the sourcing of the components of an asset, and has provided some type of ‘signature’ or ‘certification’ confirming that verification - this verification may be included in the data and information of a DCF as a record of sourcing;
5. Data asset path ethics score - as data travels between locations, such as in a DCF for example, that data may reside on, or otherwise interact with, assets with different respective ethics scores and such data may accordingly have associated with it those respective ethics scores of the assets - the times and locations of these associations of asset ethics scores to the data may be logged to enable creation of a timeline, or path, of the data through the assets, and an aggregate, such as a sum for example, of the various asset ethics scores that were associated with the data as the data traveled that path, may be determined as an asset path ethics score for the data;
6. Ethical/fair trade score - a combination of (1) the score of ethics as determined by the context set in the DCF for assets (i.e., DCF ethics score), (2) signatures provided from outside sources for assets, and the components and lifecycles of the assets and their components, may be combined to establish a DCF ethics and fair trade score;
7. AI ethics scores - the use of a context of ethical behaviors for assets, and components of assets, which are cognizant of the complexities of decision making in technology enabled by artificial intelligence;
8. Ethics asset score - similar to DCF ethics score, but applied to only a single type, or instance of, an asset, such as laptops for example;
9. BOM ethics/fair trade scores - a combination of (1) the score of ethics as determined by the context set in the DCF for components that make up an asset (i.e., DCF ethics score), and (2) signatures provided from outside sources for components of an asset, combined to establish a numerical representation, namely, the BOM DCF ethics/fair trade score;
10. Asset ethics BOM signature - a combination of (1) the score of ethics as determined by the context set in the DCF for an asset (i.e., DCF ethics score), and (2) signatures provided from outside sources for components of an asset, combined to establish a numerical representation of the contextual assessment of ethics and fair trade;
11. Data score - similar to the DCF ethics score, but applied only to a single piece of data; and
12. Gateway score - similar to a DCF ethics score but applied to a specific asset, in this case, a gateway or other physical or virtual information router.
13. Ethically sourced asset (ESA) signature - signature associated with an asset that comprises a verified assessment that all the components that are included in the Bill of Materials (BOM) for that asset have been ethically sourced - the signature may be a digital signature that can only be removed from association with the asset by the issuer of the signature.

As noted earlier, example embodiments of the invention may extend, in a DCF for example, the data collected on an asset to include asset-level BOM registration which proves that assets and their components are ethically sourced. Embodiments may then use this asset registration metadata to extend data that is created on an asset, passes through an asset, or any other action which causes the generation of one or more DCF entries. The following example is illustrative, but is not limiting of the scope of the invention.

### C.2 Association of Ethically Sourced Asset Signatures

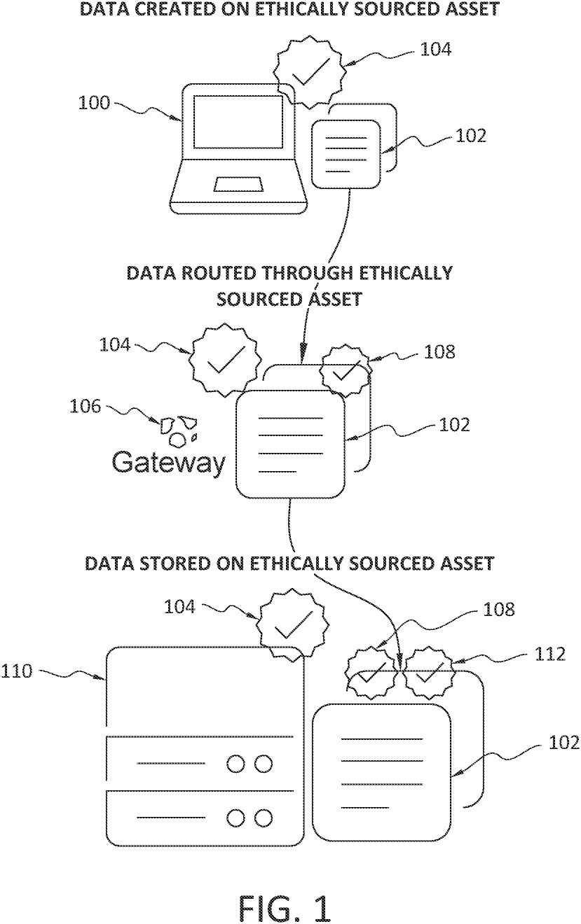

With reference now to FIG. 1, suppose that an asset 100 such as a laptop, on which data 102 is created or modified, is certified as having been ethically sourced. In that case, the asset 100 may be assigned an ‘ethically sourced asset’ (ESA) signature 104. Note that as used herein, an ESA signature that is associated with an asset comprises a verified assessment, such as by an auditor or other party, that all the components that are included in the Bill of Materials (BOM) for that asset have been ethically sourced. Depending on the embodiment, an ESA signature may be generated, and associated with an asset, internally by an organization, or by an entity external to the organization, such as a third party auditor for example.

The data 104 generated on the asset 100 may pass from the asset 100 to, for example, a gateway 106. If the gateway 106 has been ethically sourced, a further ESA signature 108 may be associated with the data 102 at/by the gateway 106. Finally, the data 102 may be passed from the gateway 106 to an ethically sourced storage 110. If the storage 110 has been ethically sourced, an ESA signature 112 may be associated with the data 102 at/by the storage environment 110.

As will be apparent from the example of FIG. 1, a company may be able to trace the data from 102 from its source at the asset 100 to the gateway 106, and finally to the storage 110. Further, the company may be able to verify, to its own satisfaction and to the satisfaction of others such as auditors or business organizations, using the ethically sourced asset signatures 104, 108, and 112, that each of the components with which the data 102 interacted was ethically sourced.

Note that any, or all, of the asset 100, gateway 106, and storage 108, may comprise a respective node of a DCF. As such, the DCF may associate data confidence information, concerning those nodes and their trustworthiness, with the data 102. In this way, a user or consumer of the data 102 may be able to access a full package of information that enables the user to evaluate the trustworthiness of the data, as well as the extent to which the data was handled by ethically sourced assets.

### C.3 Asset Registration and Component Tracing

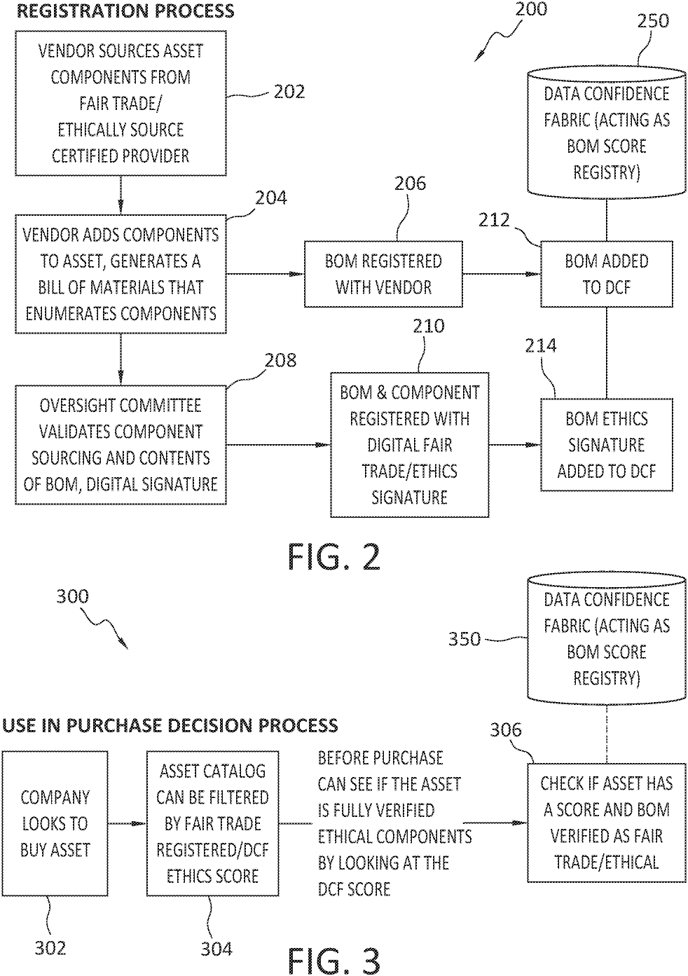

With reference next to FIG. 2, details are provided concerning methods for asset registration and component tracing, one example of which is referenced generally at 200. In general, FIG. 2 discloses an example in which a vendor ethically sources components for use in building an asset. As the asset is built, the components and information concerning their sourcing are added to a BOM for that asset. During, or after, completion of the construction of the asset, an oversight committee may validate that the component sourcing for the asset meets that minimal ethics or fair trade standards. Upon successful validation, the BOM, and an ESA signature corresponding to the asset to which the validated BOM applies, may then be added to the DCF, and may also be registered with the vendor. The addition of any asset into the DCF with this ESA signature may thus enable the DCF to recognize this asset as ethically sourced, and the BOM may provide a detailed breakdown of the various components that make up the asset.

Note that while, in some embodiments, the asset may actually, physically, be built, the physical building of an asset is not required in other embodiments. Accordingly, in other embodiments, the building of an asset may comprise, or consist of, for example, creation of construction drawings, specifications, assembly drawings, sketches, and/or any other materials, that identify, such as by illustration for example, the components of an asset, and how those components relate, and connect, to each other. The asset and its components may, or may not, actually exist at the time such materials are created.

With reference now to the particular example of FIG. 2, the example method 200 may begin when a vendor or other entity sources 202 asset components from a certified provider. The vendor may then add 204 any such components to an ‘Asset,’ and the vendor may also generate a BOM for that Asset that enumerates those components, and their respective ethical sourcing statuses.

In some embodiments, a BOM score may be generated that reflects an extent to which the components collectively included in the BOM comply with ethical sourcing requirements. The BOM score may include values in any desired range such as, for example, 0 to 10, where 0 indicates ‘non compliant’ or ‘no information’ and 10 indicates all components in the BOM have been ethically sourced. The BOM score may be a sum of individual scores of all the components listed in the BOM, and the BOM score may be registered with a DCF. An asset whose BOM score meets or exceeds a specified value may be

After the BOM is generated 204, the BOM and associated BOM score may be registered 206 with the vendor, and the BOM may also be provided to an oversight committee, which may be internal to the vendor or external to the vendor, for validation 208. Upon successful validation 208 by the oversight committee, the BOM and the asset with which the BOM is associated, may then be registered 210, or otherwise associated, with a digital fair trade/ethics signature. As shown in FIG. 2, the BOM and BOM score may also be added 212 to the DCF 250, such as by entering those items in an immutable ledger of the DCF. As well, the BOM digital fair trade/ethics signature may be added 214 to the DCF 250.

### C.4 Direct Access of Asset Ethical Registration for Use in Decision Making

The information, data, metadata, and signatures, stored in the DCF 250 may now be accessible by a call to the DCF 250. This data may be used, for example, to enable activities involving the assets themselves, such as purchasing decisions. One example of this is disclosed in FIG. 3, where a vendor may use this data to help customers make informed buying decisions. Particularly, FIG. 3 discloses the use, in a DCF, of a DCF ethics score in populating an asset catalog that may be used in connection with a purchasing process. As shown there, the certified BOM may be used to enable filtering of asset options in the purchasing process. A customer may use approach to ensure that only assets, such as laptops, servers, or storage, for example, that have the ethics or fair trade certification, are purchased.

Particularly, in the method 300 of FIG. 3, a user or other entity may initiate 302 an asset purchase process. This initiation may be as simple as defining and running a query for a particular asset, such as a laptop for example. The query, which may be directed to an asset catalogue at a vendor site for example, may generate results that may be displayed to the user. As part of the query, or after the query is run, the user may filter 304 the asset catalogue by ESA signature and/or DCF ethics score so that only those assets with an ESA signature, and/or acceptable DCF ethics score, are presented to the user for selection and possible purchase. The user may then check 306, for any asset listed in response to the query, a DCF ethics score and/or an ESA signature. This check 306 may be performed, for example, by way of a query to the DCF 350. If the DCF ethics score and/or an ESA signature, or other measures or assessments, meet the criteria of the user, the user may then complete a purchase of the asset. Such other measures and assessments may include, for example, a BOM ethics audit signature and BOM ethics score.

### C.5 Using Asset Registration Ethical Metadata to Extend Metadata

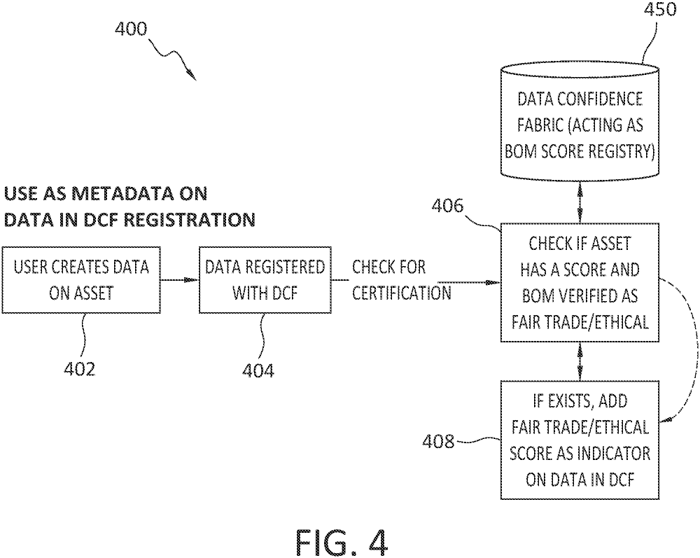

With reference now to FIG. 4, a configuration is disclosed for the addition of asset ethics metadata notation on data registration. Embodiments may use the asset label, that is, an ESA signature, to extend the metadata associated with data passing through a DCF. In the example of FIG. 4, the path of the data can be seen as the data is created on, or passes through, one or more assets, resulting in the generation of modified DCF entries. For example, embodiments may associate, with the data, additional metadata that may serve to indicate that the asset on which the data is generated or accessed, is either ethical, or is missing an ethics signature, that is, an ESA signature.

In the example method 400 of FIG. 4, a user may create or modify data 402 on an asset, such as a server, desktop or laptop computer for example. That new or modified data may then be registered 404 with the DCF 450 that includes that asset. In connection with that registration 404, metadata, such as confidence information concerning the asset, may be associated with the data, and registered with the DCF 450. As further indicated in the example of FIG. 4, a check 406, which may comprise a query of the DCF 450 by a user or a computing entity, may be performed to determine the ethical status of the asset on which the data was created or modified 402. Particularly, performance of the check 406 may include checking the DCF 450 to determine if the asset has, for example, one or more of a BOM score, BOM ethics/fair trade score and/or a DCF ethics score, and/or checking if the asset has an ESA signature, that is, if the asset has been verified as ethically sourced. If the check 406 reveals that the asset has a BOM score, BOM ethics/fair trade score, DCF ethics score, and/or the asset has an ESA signature, information including any of the aforementioned scores and signatures may be added 408 as metadata to the DCF 450, and associated in the DCF 450 with the data.

### C.6 Augmentation of Data Metadata Directly in Metadata Control Plane

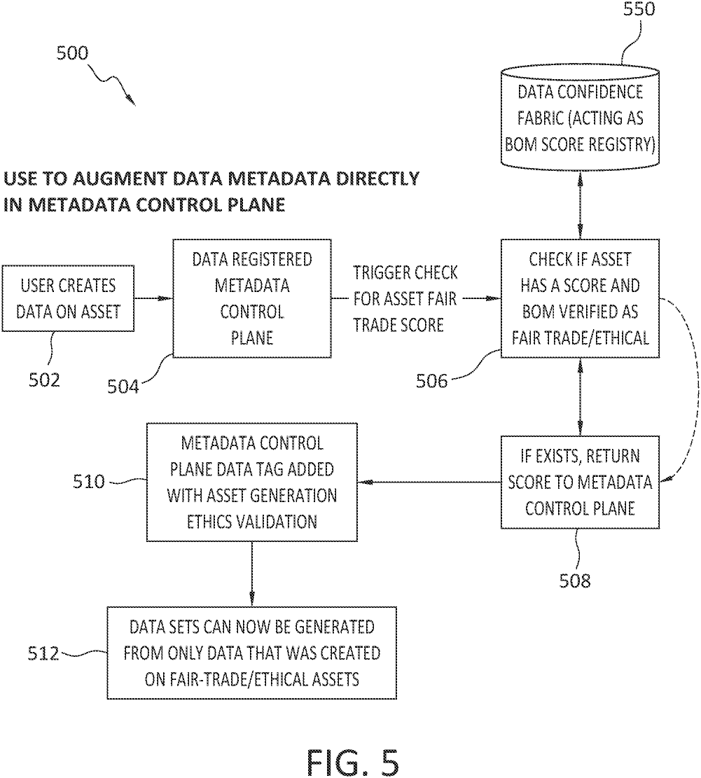

This metadata collected in a DCF, such as data confidence metadata, asset ESA signature metadata, and BOM metadata, may be made actionable in enterprises by using the metadata to populate a metadata control plane. This is shown in FIG. 5 which discloses that an ethics asset score on data may be made actionable by querying the DCF and adding the metadata tags to data for use in data set generation. To illustrate, in the example workflow disclosed in FIG. 5, new and/or modified data created on an asset may be registered with a DCF that may include, for example, an ESA signature, examples of which are discussed in connection with FIG. 1, an asset score for the asset, and/or BOM ethics/fair trade score, or other ethics indicator(s). The ethics indicator may then be returned by the DCF to the metadata control plane and added as a metadata label associated with the data. The approach disclosed in FIG. 5 may be used by enterprises to generate data sets that are only sourced on assets that meet the ethics and fair trade standards of the enterprise. Further, this approach may have business, and other, implications for the enterprise. To illustrate, new and modified data created on unethically sourced assets may pose an increased security risk in some cases, while data that has been verifiably sourced only on fair trade assets may fetch a premium due to a verified lack of material security risk associated with such fair trade assets.

With attention now to the particular illustrative example of FIG. 5, in the method 500 disclosed in FIG. 5, a user may create or modify data 502 on an asset, and the data may be registered on a metadata control plane 504. This registration 504 may also trigger a check 506 to determine if the asset and/or BOM has an ethics/fair trade score registered with the DCF 550 and, if so, such score(s) may be returned 508 to the metadata control plane. The metadata control plane may then add 510 any such score(s) as a metadata label that is associated with the new/modified data that was created 502. In this way, a user may be assured 512 that any datasets generated from the data, that is, the data that has been assigned 510 the metadata label by the metadata control plane, are compliant with ethical sourcing and data handling standards, since the asset on which that data was created/modified has been verified as compliant with such ethical sourcing and data handling standards.

### C.7 Lifecycle Flow of a Piece of Data Through Various Assets

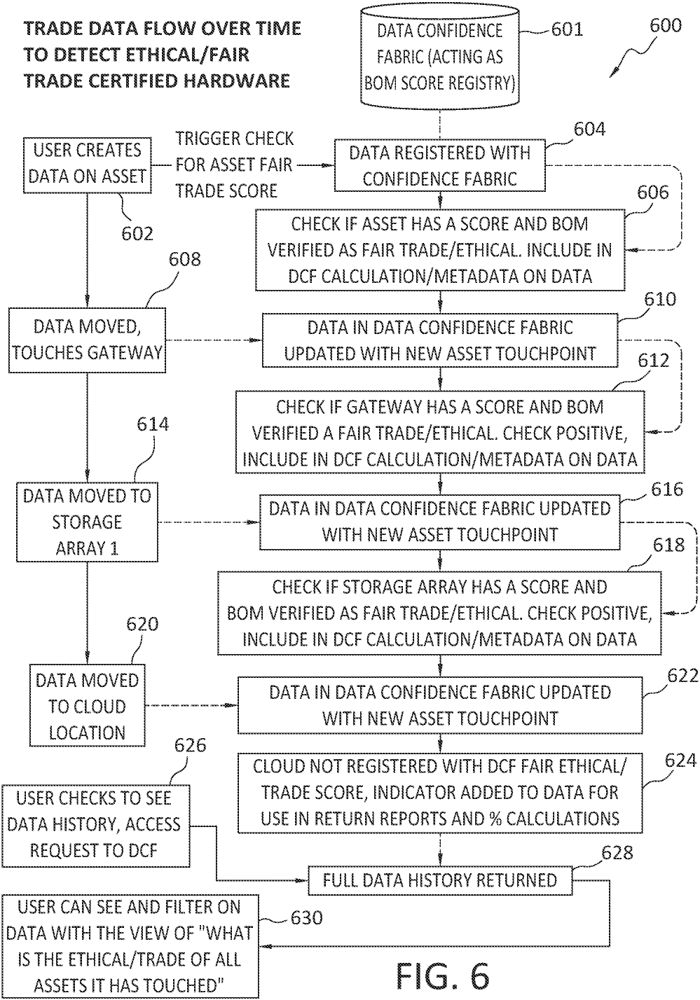

With reference now to FIG. 6, an example lifecycle flow of a piece of data through assets that do, or do not, have ethics signatures is disclosed. In general, as data flows into a cloud location, and/or into and through other asset(s), which is/are not certified or registered with a DCF as being ethically compliant, a report may be generated that returns a negative indicator for that portion of the data lifecycle. This indicator may be used to generate a score. At its simplest, this score may then be utilized to enable data users the ability to see, and filter on, data to access/view information responsive to queries such as, for example ‘What is the ethical/fair trade score of all assets this data has touched?’ This approach may be used to enable, for example, the automated use of data that has been verified to meet the ethical standards of a company.

Turning now to the illustrative workflow 600 disclosed in FIG. 6, which may or may not be performed in connection with one or more nodes of a DCF 601. Initially, a user may create 602 new or modified data, or simply ‘data’ in the example of FIG. 6, on an asset, which may comprise a node of the DCF 601, although that is not required. The data, which may be associated with metadata that identifies the asset on which the data was created/modified 602, may be registered 604 with the DCF 601. This storage 604 may automatically trigger performance of a check 606, which may comprise a query of a DCF 601 ledger for example, to determine, for example, if the asset has a DCF ethics score, and/or if the BOM associated with the asset has a BOM ethics/fair trade score. Any data and/or metadata obtained in connection with the check 606 may (1) be associated with the data that was created/modified 602 and/or (2) be used as a basis to calculate a DCF ethics score for the asset and/or for the data. Any such DCF ethics score(s) may be stored in the DCF 601, and/or elsewhere.

As another example of a data operation in connection with which example embodiments may be employed, existing data may be moved 608 from an asset, or other location, to or through a gateway, which may be a node of the DCF 601. As a result of this movement, new and/or modified metadata may be created 610, possibly automatically, that reflects the fact that the data has interacted in some way with the gateway. A check 612 may be performed of the DCF 601, possibly automatically in response to data movement 608 and/or creation 610 of new/modified metadata, to determine if the gateway has a DCF ethics score, which may be attested to by an ESA, and/or if the BOM has a BOM ethics/fair trade score. If the response to the check, or query, is affirmative, any data and/or metadata obtained in connection with the check 612 may (1) be associated with the data, and/or (2) be used as a basis to calculate a new or updated DCF ethics score for the asset and/or for the data. Any such DCF ethics score(s) may be stored in the DCF 601, and/or elsewhere.

In a further example of a data operation in connection with which example embodiments may be employed, data may pass from/through a node 614, such as a gateway for example, to a storage entity such as a storage array. As a result of this movement, new and/or modified metadata may be created 616, possibly automatically, that reflects the fact that the data has interacted with the storage array. The new and/or modified metadata may be associated with the data in the DCF 601. A check 618 may be performed of the DCF 601, possibly automatically in response to data movement 614 and/or creation 616 of new/modified metadata, to determine if the storage array has a DCF ethics score, which may be attested to by an ESA, and/or if the BOM has a BOM ethics/fair trade score. If the response to the check, or query, is affirmative, any data and/or metadata obtained in connection with the check 618 may (1) be associated with the data, and/or (2) be used as a basis to calculate a new or updated DCF ethics score for the asset, the storage array in this case, and/or for the data. Any such DCF ethics score(s) may be stored in the DCF 601, and/or elsewhere.

In some cases, and with continued reference to the example of FIG. 6, data may interact in some way with an asset that has not been verified as complying with applicable ethics standards and regulations. To illustrate, suppose that data is moved 620, such as from a storage array, to a cloud site that has not been verified as complying with ethical standards and regulations employed by the entity that created the data. As a result of this movement 620, new and/or modified metadata may be created 622, possibly automatically, that reflects the fact that the data has interacted with the storage array. The new and/or modified metadata may be associated with the data in the DCF 601. As shown at 624, a check of the DCF 601 may be performed, possibly automatically, that reveals that the cloud site does not have a DCF ethics/fair trade score, nor a BOM ethics/fair trade score. In this case, an indicator may be associated with the data, indicating the lack of such score(s). The indicator, which may be numerical, may be used in the generation of reports concerning the data, and or in the calculation of various ethics measures, such as a data DCF ethics score for example, relating to the data that was moved to the cloud site.

At any time in the lifecycle of a piece of data, or a dataset, a user may check 626 the DCF 601, such as by performing a query, to view the historical record for that data. In some embodiments, reports may be automatically generated and sent to a user after any change, or specified changes, to the historical record. In response to the check and/or automatically, the DCF 602 may return 628 a full history, or only portions of the history specified by a user, to the user. In general, the user may filter 630 the returned historical record on any field(s) that are of interest to the user. Accordingly, in some embodiments, the user may filter 630 the returned data with a further refinement that identifies, to the user from the historical record, the respective ethical/fair trade score(s) of any asset(s) specified by the user.

As noted earlier, the workflow 600 shown in FIG. 6 is presented by way of example, and not limitation, and any number of variations may be made within the scope of the invention. For example, not all of the operations disclosed in FIG. 6 may be performed in every case - in some embodiments, the data may not be moved 620 to a cloud location, but may remain at another location, such as a storage array. As another example, data may be modified before it transits from one asset to another, such as between the time that the data moves from a storage array to a cloud site. That is, the order of operations disclosed in FIG. 6 may be varied.

### D. Further Discussion

As disclosed herein, example embodiments may possess various useful features and functionalities, although no embodiment is required to include any particular feature(s) or functionality (ies). For example, embodiments may operate to record and assign component and asset BOM ethics/fair trade scores to infrastructure such as, but not limited to, edge computing sites, edge devices, near-edge computing sites, data centers, client hardware, and client premises, in a connected environment, which may or may not comprise a DCF that comprises one or more nodes in the form of, or including, a piece of infrastructure such as an edge device for example. Further, embodiments may assign an ethics/fair trade score to data, which may comprise one or more DCF records and/or associated metadata, that is generated on and/or passes through infrastructure such as hardware. Subsequent use of the metadata may be employed in automated decision making, the formation of datasets, and in making asset purchase, or rental, determinations.

As another example, embodiments may define and employ data asset path ethics scores in determining a value of data for use in data marketplaces. That is, embodiments may value data based in whole or in part on a path taken by that data through an infrastructure, or portion of an infrastructure, such as DCF for example.

Further, embodiments may define and employ a BOM ethics/fair trade score, ESA signature, and/or BOM ethics audit signature, in determining workflow and data transport orchestration, and data paths. For example, an embodiment may advise a user to route data away from, or around, components that are not ethically sourced, which could affect as-a-service (aaS) billing. That is, ethically sourced data path assets would get more of the traffic and, possibly, create greater revenue for the asset owner(s) than would be the case if one or more of the data path assets had not been verifiably ethically sourced.

Following are some example use cases for some embodiments of the invention. Such use cases are provided by way of illustration, and are not intended to limit the scope of the invention in any way. For example, embodiments may implement, or at least enable, a comparison of assets by ethics signed components to aid a user in purchasing decisions. In this scenario, a user may compare the respective DCF scores, which may be presented to the user in ranked order, for example, of various assets as a way to aid selection of an asset for purchase, where an asset with a relatively higher DCF score may be preferred by a user over an asset with a relatively lower DCF score.

As another example use case, embodiments may provide the ability to source data from only assets that are ethics-certified. In this way, a company or other creator or consumer of data may have some assurance that the data conforms to applicable ethical standards.

Embodiments may operate to orchestrate sensitive data to only route through ethics-certified hardware/gateways, or other infrastructure assets. This approach may increase the value of the data, while also encouraging owners of uncertified assets to meaningfully consider the impact of the lack of certification on their revenue stream.

Finally, embodiments may provide a decision point or criterial for users deciding where to source data from. Particularly, where data sources and associated datasets are otherwise comparable, embodiments may able a user to identify, and user, the dataset that better complies with the ethical requirements of the user such as, for example, the dataset with the highest, or relatively higher, data score.

### E. Aspects of Example Methods

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: building a computing asset that includes a component that has been verified as being ethically sourced; generating a bill of material for the computing asset that identifies the component; adding the bill of material to a data confidence fabric that includes the computing asset as a node; registering the component and the bill of material in the data confidence fabric; and associating a digital fair trade/ethics signature with the component, wherein the digital fair trade/ethics signature is stored in the data confidence fabric in association with the component.

Embodiment 2. The method as recited in embodiment 1, wherein the building of the computing asset comprises preparation of materials that indicate how the component relates to, and interacts with, any other components of the computing asset.

Embodiment 3. The method as recited in any of embodiments 1-2, wherein registering the bill of material in the data confidence fabric comprises storing a bill of materials score in the data confidence fabric.

Embodiment 4. The method as recited in any of embodiments 1-3, further comprising generating a data confidence fabric ethics score for the computing asset, and registering the data confidence fabric ethics score in the data confidence fabric.

Embodiment 5. The method as recited in embodiment 4, further comprising associating a DCF ethics signature with the confidence fabric ethics score for the computing asset.

Embodiment 6. The method as recited in any of embodiments 1-5, further comprising associating an ‘ethically sourced asset’ signature with the computing asset.

Embodiment 7. The method as recited in any of embodiments 1-6, further comprising assigning an ethics score to data that has interacted with the computing asset.

Embodiment 8. The method as recited in embodiment 7, further comprising receiving a request for the data, wherein the request is based on the ethics score that has been assigned to the data.

Embodiment 9. The method as recited in embodiment 7, further comprising defining a data path for the data, wherein the data path includes the computing asset, and assigning a data path ethics score to the data path.

Embodiment 10. The method as recited in any of embodiments 1-9, further comprising orchestrating data transmission over a data path that includes the computing asset, and the data path avoids another computing asset that has not been verified as ethically sourced.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

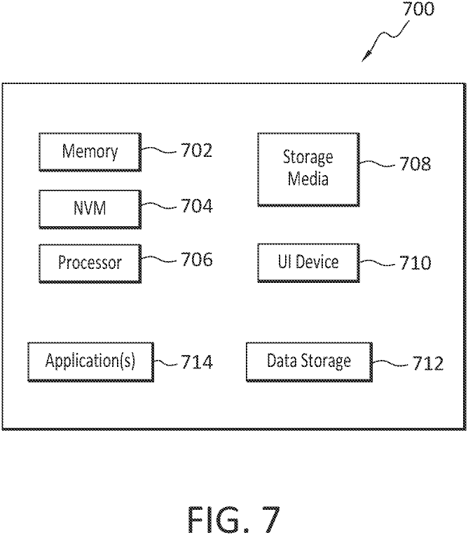

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI (user interface) device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
building a computing asset that includes a component that has been verified as being ethically sourced;
generating a bill of material for the computing asset that identifies the component;
adding the bill of material to a data confidence fabric that includes the computing asset as a node;
registering the component and the bill of material in the data confidence fabric; and
associating a digital fair trade/ethics signature with the component, wherein the digital fair trade/ethics signature is stored in the data confidence fabric in association with the component.

2. The method as recited in claim 1, wherein the building of the computing asset comprises preparation of materials that indicate how the component relates to, and interacts with, any other components of the computing asset.

3. The method as recited in claim 1, wherein registering the bill of material in the data confidence fabric comprises storing a bill of materials score in the data confidence fabric.

4. The method as recited in claim 1, further comprising generating a data confidence fabric ethics score for the computing asset, and registering the data confidence fabric ethics score in the data confidence fabric.

5. The method as recited in claim 4, further comprising associating a DCF ethics signature with the confidence fabric ethics score for the computing asset.

6. The method as recited in claim 1, further comprising associating an ‘ethically sourced asset’ signature with the computing asset.

7. The method as recited in claim 1, further comprising assigning an ethics score to data that has interacted with the computing asset.

8. The method as recited in claim 7, further comprising receiving a request for the data, wherein the request is based on the ethics score that has been assigned to the data.

9. The method as recited in claim 7, further comprising defining a data path for the data, wherein the data path includes the computing asset, and assigning a data path ethics score to the data path.

10. The method as recited in claim 1, further comprising orchestrating data transmission over a data path that includes the computing asset, and the data path avoids another computing asset that has not been verified as ethically sourced.

11. A non-transitory storage medium having stored therein instructions that are executable by one or more hardware processors to perform operations comprising:
building a computing asset that includes a component that has been verified as being ethically sourced;
generating a bill of material for the computing asset that identifies the component;
adding the bill of material to a data confidence fabric that includes the computing asset as a node;
registering the component and the bill of material in the data confidence fabric; and
associating a digital fair trade/ethics signature with the component, wherein the digital fair trade/ethics signature is stored in the data confidence fabric in association with the component.

12. The non-transitory storage medium as recited in claim 11, wherein the building of the computing asset comprises preparation of materials that indicate how the component relates to, and interacts with, any other components of the computing asset.

13. The non-transitory storage medium as recited in claim 11, wherein registering the bill of material in the data confidence fabric comprises storing a bill of materials score in the data confidence fabric.

14. The non-transitory storage medium as recited in claim 11, wherein the operations further comprise generating a data confidence fabric ethics score for the computing asset, and registering the data confidence fabric ethics score in the data confidence fabric.

15. The non-transitory storage medium as recited in claim 14, wherein the operations further comprise associating a DCF ethics signature with the confidence fabric ethics score for the computing asset.

16. The non-transitory storage medium as recited in claim 11, wherein the operations further comprise associating an ‘ethically sourced asset’ signature with the computing asset.

17. The non-transitory storage medium as recited in claim 11, wherein the operations further comprise assigning an ethics score to data that has interacted with the computing asset.

18. The non-transitory storage medium as recited in claim 17, wherein the operations further comprise receiving a request for the data, wherein the request is based on the ethics score that has been assigned to the data.

19. The non-transitory storage medium as recited in claim 17, wherein the operations further comprise defining a data path for the data, wherein the data path includes the computing asset, and assigning a data path ethics score to the data path.

20. The non-transitory storage medium as recited in claim 11, wherein the operations further comprise orchestrating data transmission over a data path that includes the computing asset, and the data path avoids another computing asset that has not been verified as ethically sourced.
